(19) United States
(12) Patent Application Publication
(10) Pub. No.: US 2016/0377273 A1
(43) Pub. Date: Dec. 29, 2016

(54) LIGHTING DEVICE FOR USE WITH AN ELECTRIC-MOTOR FURNITURE DRIVE

(71) Applicant: DEWERTOKIN GMBH, Kirchlengern (DE)

(72) Inventor: ARMIN HILLE, Bielefeld (DE)

(73) Assignee: DEWERTOKIN GMBH, 32278 Kirchlengern (DE)

(21) Appl. No.: 15/038,888

(22) PCT Filed: Nov. 25, 2014
(86) PCT No.: PCT/EP2014/075564

§ 371 Date: May 24, 2016

(30) Foreign Application Priority Data
Nov. 25, 2013 (DE) 20 2013 105 360.0

(51) Int. Cl. F21V 23/00; H05B 37/02; H05B 33/08; A47C 31/00; F21V 23/04; A47C 17/16; A47C 17/86; F21V 23/06; F21V 33/00

(52) U.S. Cl. CPC F21V 23/005; F21V 23/06; H05B 37/0281; H05B 33/0845; H05B 37/0254; F21V 33/0012; F21V 23/04; F21V 23/0435; A47C 17/162; A47C 17/86; A47C 31/00; F21Y 2115/10

(57) ABSTRACT

The invention relates to a lighting device (30) having at least one lighting means (32) for use with an electric-motor furniture drive, which electric-motor furniture drive has at least one electric-motor adjustment drive (7, 8), wherein the electric-motor adjustment drive (7, 8) is connected to a base unit (10), which is coupled to an operating unit (20), by means of which the at least one electric-motor adjustment drive (7, 8) can be actuated, wherein the lighting device (30) has at least two plug connectors (34, 35), by means of which the lighting device can be connected to the base unit (10) or to the at least one electric-motor adjustment drive (7, 8) on the one hand and to the operating unit (20) on the other hand, wherein an electrical connection is established between the base unit (10) and the operating unit (20) or the at least one electric-motor adjustment drive (7, 8); by means of the lighting device (30).

The invention relates to a lighting device having at least one illuminant for use with an electric-motor furniture drive, which has at least one electric-motor adjustment drive, wherein it is connected to a base unit, which is coupled to an operating unit, via which the at least one electric-motor adjustment drive can be actuated.

Electric-motor furniture drives are installed in beds, for example, to enable adjustment of head and/or foot parts in a comfortable manner. In the case of hospital beds or care beds in particular, it has proven to be practical if a specific background illumination for the room can be turned on from the bed, which makes it easier to get up at night, without the room lighting or a reading lamp having to be switched on for this purpose. So-called underbed lights are known for this purpose, which create sufficient brightness in the room to be able to get up from the bed and enter the bed without risk even when the room lighting is turned off.

For example, such an underbed light is known from document DE 298 06 588 U1, which is integrated in a base unit, designed as a control unit, of an electric-motor furniture drive. This solution is linked to a low installation effort, but can only be produced by a relatively costly replacement of the control unit in the case of an electric-motor furniture drive.

An underbed light usable in conjunction with an electric-motor furniture drive is also known from document DE 20 2009 003 911 U1, from which a grid connection of the control unit of the electric-motor furniture drive can be connected upstream and which can be turned on via a separate switch. Such an underbed light can be retrofitted in a simple manner, however, the operation thereof is not very convenient because of the separate switch. Because of the use of grid voltage to supply the underbed light, in addition, the grid voltage firstly has to be transformed into a low voltage if light-emitting diodes are used as the illuminant. In particular in the case of care beds and hospital beds, an installation of devices having grid voltage connection on the bed is complex, since a high insulation class is to be maintained as a result of the prevailing safety and hygiene provisions, which results in a corresponding more complex electromechanical construction of the devices.

It is therefore an object of the present invention to provide a lighting device usable in conjunction with an electric-motor furniture drive, which can be retrofitted in a simple manner on beds, but also on other items of furniture, for example, armchairs, which has a simple electromechanical construction, and which can be operated conveniently with the aid of the operating unit of the electric-motor furniture drive.

This object is achieved by a lighting device having the features of the independent claim. Advantageous embodiments and refinements are the subject matter of the dependent claims.

A lighting device according to the invention of the type mentioned at the outset is distinguished in that it has at least two plug connectors, via which it is connectable to the base unit, on the one hand, and the operating unit or the at least one electric-motor adjustment drive, on the other hand, wherein an electrical connection between the base unit and operating unit or the at least one electric-motor adjustment drive is produced via the lighting device.

By interconnecting the lighting device between the base unit and the operating unit or between the base unit and the adjustment drive, a supply voltage, which is output from the base unit at the plug connector and is used, for example, for the power supply of the operating unit or for operating the adjustment drive, can be used to supply the illuminant of the lighting device. The supply voltage of the operating unit is typically a low voltage and in particular a low DC voltage, so that the operating voltage can be provide in a simple manner for the illuminant. In addition, control lines of the operating unit, which relay an actuation of operating elements of the operating unit to the base unit, can be analyzed, so that the illuminant can be turned on and off conveniently via the operating unit.

A further advantage is that multiple lighting units can be connected in succession between the base unit and the operating unit or the at least one adjustment drive, so that different demands, for example, on the light distribution and/or the light intensity can be fulfilled flexibly with only one main type of the lighting device.

In one advantageous embodiment of the lighting device, the at least one illuminant is a light-emitting diode. A plurality of light-emitting diodes can preferably also be used as the illuminant, wherein a terminal can be provided, via which further light-emitting diodes can be concatenated on the plurality of light-emitting diodes. Light-emitting diodes are a compact and energy-saving light source. The ability to concatenate modules each having multiple light-emitting diodes represents a sufficiently bright and flexibly expandable light source.

In a further advantageous embodiment of the lighting device, a regulator is connected upstream of the at least one illuminant, wherein the regulator is designed as a voltage and/or current regulator. The regulator can preferably be designed as a wide-range voltage and/or current regulator. The regulator prevents the light intensity of the illuminant from varying in the event of a variation of the supply voltage of the operating unit. In this manner, “flickering” of the illuminant, for example, when one of the electric motors of the adjustment drive starts, can be suppressed.

If the operating unit is connected via a control cable to the base unit, the regulator is preferably configured to monitor signal lines of the control cable, and to turn the illuminant on or off as a function of signals on the signal lines. The regulator is particularly preferably configured so that the at least one illuminant is turned on upon an actuation of an operating element of the operating unit and/or the at least one illuminant is turned off in a time-controlled manner.

In a further advantageous embodiment, the lighting device comprises an energy store, for example, a high-capacity capacitor or a rechargeable battery. The energy store can be charged when supply voltage is provided and enables the illuminant to be operated at least temporarily even when supply voltage is absent. This is advantageous in particular for a lighting device which is connected between the base unit and an electric-motor adjustment drive.

In a further advantageous embodiment of the lighting device, at least one of the two plug connectors is connected as a plug or a coupling via a supply cable to a housing of the lighting device. In this case, the other of the plug connectors can be arranged as an installed plug and/or an installed socket in a housing of the lighting device. Alternatively, in addition to the (main) housing of the lighting device, a separate plug housing can be provided, in which both plug connectors are arranged as installed plugs or sockets, wherein the separate plug housing and the housing of the lighting device are connected to one another via a connection cable. The mentioned embodiments enable a flexible arrangement of the lighting device on the item of furniture.

The invention will be explained in greater detail hereafter on the basis of exemplary embodiments with the aid of figures. In the figures:

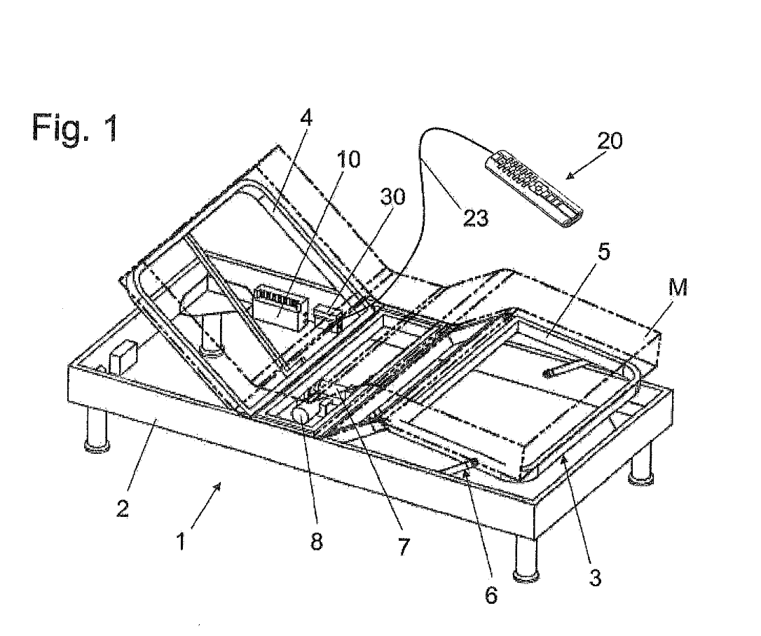

FIG. 1 shows a schematic perspective view of a bed having an electric-motor furniture drive;

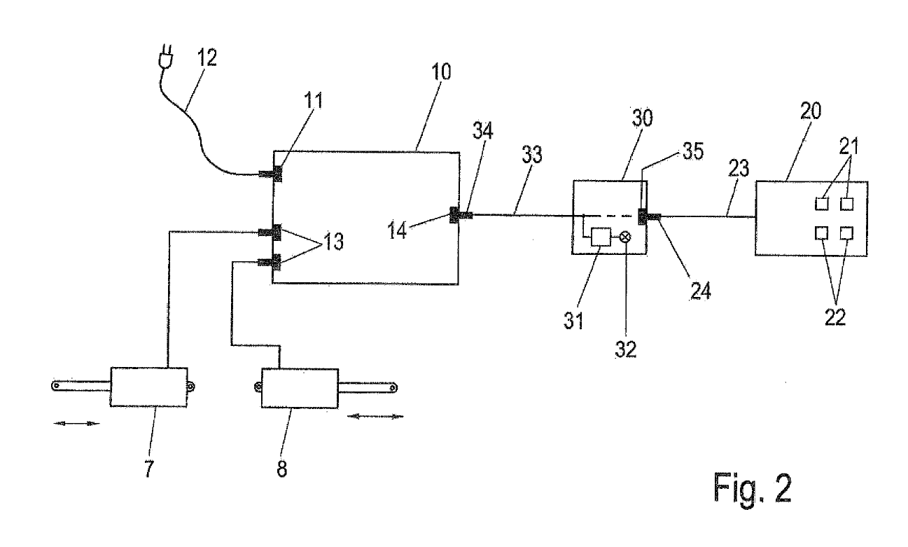

FIG. 2 shows a block diagram of an electric-motor furniture drive having a lighting device in a first exemplary embodiment; and

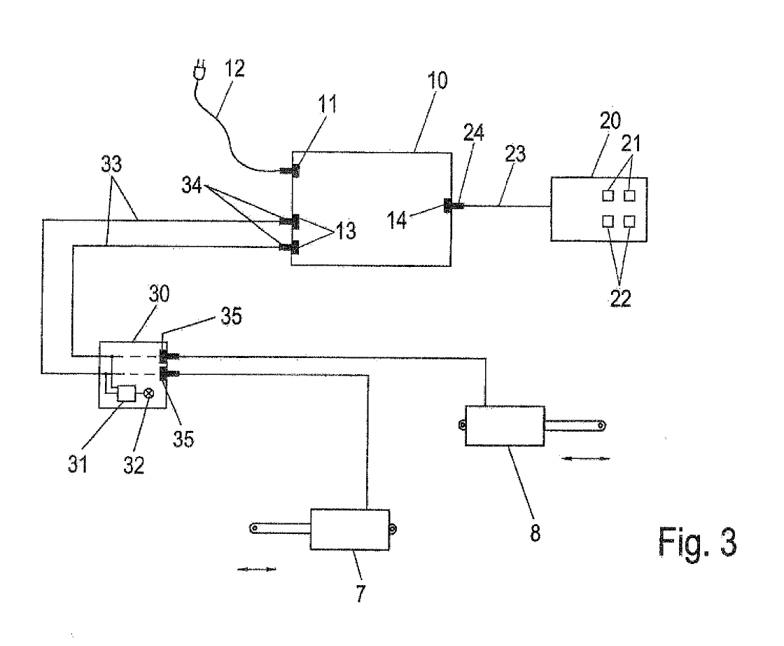

FIG. 3 shows a block diagram of an electric-motor furniture drive having a lighting device in a second exemplary embodiment.

FIG. 1 shows a bed 1, which is equipped with an electric-motor furniture drive, as an example of an item of furniture. The bed 1 has a base frame 2, which carries a support surface 3 having mattress M laid thereon. The support surface 3 is designed having a so-called movement fitting and has a movably mounted back part 4 and leg part 5. The movement is implemented as displaceable and/or pivotable by suitable levers and/or linkages 6.

Such a support surface 3 can be designed in the bed shown, for example, as a slatted frame having springy yielding slats, as a spring frame having springy yielding segments, or as a rigid, non-yielding support plate or combinations thereof.

The movably mounted back part 4 and the leg part 5 are each coupled to an electric-motor adjustment drive 7, 8. The back part 4 is thus coupled to the electric-motor adjustment drive 7. The electric-motor adjustment drive 8 is provided for the movement and/or adjustment of the leg part 5.

The electric-motor adjustment drives 7, 8 are designed as linear drives here. The linear drives have one or a number of electric motors, wherein a speed-reducing gear unit having at least one gear stage is connected downstream of each motor. A further gear unit, for example, in the form of a threaded spindle gear unit, which generates a linear movement of the output element from the rotational movement of the motor, can be connected downstream of the speed-reducing gear unit. The last gear element or a further element connected thereto forms an output element. The output element of the respective electric-motor adjustment drive is connected to the respective movable furniture part (back part 4, leg part 5) or alternatively to a component connected to the base frame 2, so that during operation of the electric motor of the respective adjustment drive 7, 8, the movable furniture components 4, 5 can be adjusted in relation to one another and/or in relation to the base frame 2.

The electric-motor adjustment drives 7, 8 are connected to a base unit 10. This connection can be embodied, for example, as a pluggable cable connection (not shown in greater detail here). The base unit 10 has an electrical supply unit, which provides the electrical energy, for example, from the grid, for the electric-motor adjustment drives 7, 8. For this purpose, the base unit 10 is connectable in this example via a grid cable (not shown) to a grid plug having a grid connection. The grid plug conducts the input-side grid voltage via the grid cable to the electrical supply unit of the base unit 10, which emits a low voltage in the form of a DC voltage on the secondary side and relays it to a motor controller.

Alternatively thereto, a grid-dependent voltage supply (not shown in greater detail) having grid input and having secondary-side low-voltage output, which supplies the low voltage in the form of a DC voltage via a line, is connected upstream of the base unit 10.

An operating unit 20, which has operating elements 21, 22, by means of which the adjustment drives 7, 8 can be activated, is connected to the base unit 10. The operating unit 20, also called a manual switch, is connected via a control cable 23, i.e., in a wired manner in this embodiment, to the base unit 10.

In an alternative embodiment, the operating unit 20 can be designed as a radio manual switch or as an infrared manual switch and can be connected via a wireless transmission link to the base unit 10.

The operating elements 21, 22 are embodied as buttons as an example here. The operating elements 21 are used in this case, for example, for raising the respective movable furniture part and the operating elements 22 are used for lowering it.

For this purpose, the base unit 10 can be designed as a control unit for the adjustment drives 7, 8, which has switching elements, for example, relays or semiconductor power switches, via which voltage is applied to the adjustment drives 7, 8 upon actuation of the operating elements 21, 22 of the operating unit 20. In such a case, an activation signal for the switching elements is transmitted via the control cable 23. Alternatively, it is possible that the operating elements 21, 22 directly switch the current required for operating the adjustment drives 7, 8, so that the control function is implemented essentially completely in the operating unit 20 and the base unit 10 is to be considered more of a terminal unit.

In addition to the operating elements 21, 22, further operating elements can optionally be provided, via which auxiliary functions can be operable. Such auxiliary functions can be devices connected to the base unit 10, for example, such as a reading lamp, an emergency call unit, and/or a radio or another media device.

Furthermore, a lighting device 30 is arranged on the bed frame of the bed 1 of FIG. 1, which is coupled to the base unit 10 and to the operating unit 20.

According to the illustration of FIG. 1, the lighting device 30 is cuboid and is constructed having an add-on envelope housing. A first alternative is formed by an installation lighting device, wherein the lighting device 30 is incorporated or inserted into a recess of the furniture. A further alternative of a lighting device 30 is a rod-shaped, strip-shaped structure. In the refinement thereof, multiple strip-shaped lighting elements can be connected to one another, wherein the connection is produced via electrical and/or mechanical connections, so that a plurality of lighting elements, connecting elements, or cables connected to one another forms the lighting device 30.

The interaction of the base unit 10, the operating unit 20, and the lighting device 30 is shown in greater detail in FIG. 2 in a block diagram. The arrangement shown in FIG. 2 can be arranged in the bed 1 of FIG. 1, for example.

The base unit 10 has a supply terminal 11, which is designed here as a grid cable terminal for plugging in a grid cable 12. In an alternative embodiment, the supply terminal 11 can be designed as a low-voltage terminal, which is connected via an external power supply, for example, a plug-in power supply, to the power grid. The base unit 10 and, via this, the adjustment drives 7, 8 are supplied with power via the supply terminal 11. The adjustment drives 7, 8 are connected in the present example to corresponding adjustment drive terminals 13. Electric motors arranged in the adjustment drives 7, 8 are activated directly and supplied with power via these adjustment drive terminals 13. In addition, a signal of an end switch arranged in the respective adjustment drive 7, 8 can be transmitted to the base unit 10 via the adjustment drive terminals 13. However, it can also be provided that the end switch signal is analyzed in the respective adjustment drive 7, 8. Furthermore, signal lines can be provided, via which a position of an output element of the adjustment drive 7, 8 is transmitted to the base unit 10, to take this position signal into consideration in the activation of the adjustment drives 7, 8.

Furthermore, a plug connector 14 is arranged on the base unit 10, via which the operating unit 20 can be connected to the base unit 10. For this purpose, the operating unit 20 has, at the end of the control cable 23, a plug connector 24 complementary to the plug connector 14, which is provided for the purpose of being plugged directly into the plug connector 14 of the base unit 10. For easier differentiability, the complementary plug connector 24 is referred to hereafter as the counter plug connector 24.

Notwithstanding this, it is provided according to the invention in the exemplary embodiment of FIG. 2 that the operating unit 20 is connected to the base unit 10 via the lighting device 30. The lighting device 30 is therefore looped in between the base unit 10 and the operating unit 20.

The lighting device 30 has a regulator 31, from which an illuminant 32 is supplied with power and activated. The illuminant 32 is, for example, at least one light-emitting diode, preferably also an arrangement of multiple light-emitting diodes. For example, light-emitting diode arrays can be used, in which a plurality of light-emitting diodes are arranged successively on an oblong and narrow printed circuit board. The printed circuit board can be inserted into a plastic or aluminum profile, on which a transparent cover is placed or is also inserted toward at least one side. In this case, it can additionally be provided that the light-emitting diode arrays have plug connectors on the end faces thereof, by which they can be arrayed on one another to increase the light power if needed. Each of the light-emitting diode arrays can have a separate voltage or current regulator.

The lighting device 30 has a plug connector 34, which is complementary to the plug connector 14 and is therefore structurally equivalent to the counter plug connector 24 of the operating unit 20 with respect to the plug image. The complementary plug connector 34 is also referred to as a counter plug connector 34 hereafter. Furthermore, the lighting device 30 has a plug connector 35, which corresponds in its construction to the plug connector 14 of the operating device 10. The counter plug connector 34 and the plug connector 35 enable the lighting device 30 to be looped in between base unit 10 and operating unit 20.

In the exemplary embodiment illustrated in FIG. 2, the lighting device 30 is housed in a housing, in which the plug connector 35 is designed and arranged as a socket. In contrast, the counter plug connector 34 is designed as a plug which is connected via a supply cable 33 to the lighting device 30. Other constructions of the counter plug connector 34 and the plug connector 35 are possible in alternative embodiments. For example, the plug connector 35 can also be designed as a coupling and can be connected via a supply cable to the lighting device 30. If the counter plug connector 34 is also connected, like the plug connector 35, via a supply cable designed as a plug or coupling, to the lighting device 30, this supply cable can be designed in the form of a Y-cable or a T-cable, which corresponds to a T-part having branching of a passage. It is also possible to arrange the counter plug connector 34 and the plug connector 35 as plug and socket, respectively, in a separate housing, which is connected via a connection cable to a main housing of the lighting device 30. Such a separate housing then assumes the function of a T-part.

By interconnecting the lighting device 30, a supply voltage, which is output by the base unit 10 at the plug connector 14 and is used for the power supply of the operating unit 20, and which is typically a low voltage and in particular a low DC voltage, can be used for supplying the illuminant 32 of the lighting device 30. For this purpose, the regulator 31 is preferably designed as a wide-range voltage and/or current regulator, which prevents the illuminant 32 from varying in its intensity in the event of a variation of the supply voltage of the operating unit 20. In this way, “flickering” of the illuminant 32 can be prevented, for example, during the starting of one of the electric motors of the adjustment drives 7, 8. Independently of whether the supply voltage for the respective electric motor collapses because of a gradual or a sudden high electric load due to the nature of the transformer of the grid-operated voltage supply, the mentioned current regulation ensures a consistent energy supply of the illuminant 32, so that the luminosity remains constant in regular operation of the furniture drive.

Furthermore, the lighting device 30 can have an energy store, for example, a high-capacity capacitor or a rechargeable battery. The energy store can, on the one hand, compensate for a varying supply voltage and, on the other hand, provide a use of a supply of the illuminant 32 at least for a limited period of time, even if the supply voltage is not available.

It is obvious that not only one, but rather if needed multiple lighting units 30 can also be connected in succession between the base unit 10 and the operating unit 20.

In addition, a logic circuit can be arranged in the regulator 31, which analyzes control lines of the control cable 23 and turns on the illuminant 32 as a function of signals on these control lines. For example, it can be provided that an actuation of each operating element 21, 22 of the operating unit 20 is detected on the basis of the signals on the control lines and the illuminant 32 is turned on for a predefined time after detected actuation. In particular, the turning off can be performed with a time delay and/or with continuous or graduated light intensity of the illuminant 32, so that the user is not surprised by abrupt extinguishing of the illumination. Such a variation of the light intensity can also be performed during the turning on, wherein shorter transition times are preferred, however.

If an auxiliary operating element, which is provided especially for turning on a lighting device, is provided on the operating unit 20, it can be analyzed for the continuous turning on and off of the illuminant. Furthermore, operating units 20 are known, which have sensors, for example, heat, inclination, or motion sensors. A control signal of such sensors can also be used by the regulator 31 for activating the illuminant 32, so that the illuminant is already turned on, for example, in the event of a movement of the operating unit 20.

FIG. 3 shows a further exemplary embodiment of an electric-motor furniture drive having a lighting device 30 according to the invention in a block diagram in the same manner as shown in FIG. 2. The arrangement shown in FIG. 3 can also be used in the bed of FIG. 1, for example. Identical reference signs identify identical or identically acting elements in FIG. 3 as in the above-described figures.

The arrangement shown in FIG. 3 again comprises a base unit 10, which is supplied with power via a supply terminal 11 and is coupled to an operating unit 20. The base unit 10 is designed as a control unit for adjustment drives 7, 8, wherein in the present case the adjustment drives 7, 8 are connected via the lighting device 30 to the base unit 10.

Notwithstanding the exemplary embodiment of FIG. 2, it is thus provided here that the lighting device 30 is looped between the base unit 10 and the adjustment drives 7, 8. In the illustrated example, the lighting device 30 is looped in between the two adjustment drives 7, 8, because of which it has two plug connectors 35 for connecting one adjustment drive 7, 8 in each case and also two counter plug connectors 34 for contacting the base unit 10. Alternatively, it is also possible to only loop in the lighting device 30 between the base unit 10 and one of the adjustment drives 7, 8.

Upon actuation of an operating element 21, 22 of the operating unit 20, at least one of the adjustment drives 7, 8 is energized. The lighting device 30 is accordingly also supplied with power and activates the illuminant 32. An illumination by the lighting device 30 can thus be produced at least for the time of the actuation of an operating element 21, 22.

If the lighting device 30 is provided with an energy store, in particular a high-capacity capacitor, it can absorb energy during the operation of the adjustment drives 7, 8. The illuminant 32 can then be operated for some time using the stored energy when the operating element 21, 22 is already no longer actuated and the adjustment drives 7, 8 are not energized.

### LIST OF REFERENCE SIGNS

1 bed

2 base frame

3 support surface

4 back part

5 leg part

6 lever or linkage

7, 8 electric-motor adjustment drive

10 base unit

11 supply terminal

12 grid cable

13 adjustment drive terminal

14 plug connector

20 operating unit

21, 22 operating element

23 control cable

24 counter plug connector

30 lighting device

31 regulator

32 illuminant

33 supply cable

34 counter plug connector

35 plug connector

M mattress

1.-11. (canceled)

12. A lighting device, comprising:
at least one illuminant operably connected to an electric-motor furniture drive having at least one electric-motor adjustment drive; and
at least two plug connectors configured to connect the lighting device to the electric-motor furniture drive in one of two ways, a first way in which the lighting device is connected via the at least two plug connectors to the electric-motor furniture drive via a base unit and an operating unit, respectively, which are operably connected to the at least one electric-motor adjustment drive, a second way in which the lighting device is connected via the at least two plug connectors to the electric-motor furniture drive via the base unit and the at least one electric-motor adjustment drive; said lighting device establishing an electrical connection between the base unit and the operating unit or between the base unit the at least one electric-motor adjustment drive.

13. The lighting device of claim 12, wherein the at least one illuminant is a light-emitting diode.

14. The lighting device of claim 12, wherein the illuminant includes a plurality of light-emitting diodes, and further comprising a terminal configured to enable further light-emitting diodes to be arranged juxtaposed to the plurality of light-emitting diodes.

15. The lighting device of claim 12, further comprising at least one regulator connected upstream of the illuminant and configured as a voltage and/or current regulator.

16. The lighting device of claim 15, wherein the regulator is configured to monitor signals transmitted via a control cable between the operating unit to the base unit so as to turn the illuminant on and off in response to the signals.

17. The lighting device of claim 16, wherein the regulator is configured to turn on the at least one illuminant when an operating element of the operating unit is actuated.

18. The lighting device of claim 16, wherein the regulator is configured to turn off the at least one illuminant in a time-controlled manner.

19. The lighting device of claim 12, further comprising a housing, at least one of the two plug connectors being configured as a plug or a coupling for connection to the housing via a supply cable.

20. The lighting device of claim 12, further comprising a housing, at least one of the plug connectors being configured as an installed plug and/or an installed socket in the housing.

21. The lighting device of claim 12, further comprising a housing, a separate plug housing configured to accommodate the at least two plug connectors configured as an installed plug or socket, and a connection cable connecting the housing and the plug housing to one another.

22. The lighting device of claim 12, further comprising an energy store storing electrical energy during operation of the at least one electric-motor adjustment drive and to feed supply voltage to the illuminant, when the at least one electric-motor adjustment drive is idle.

23. The lighting device of claim 12, wherein the energy store is a high-capacity capacitor.

24. An electric-motor furniture drive, comprising:
a base unit configured to provide electrical energy;
at least one electric-motor adjustment drive connected to the base unit;
an operating unit coupled to the base unit and configured to actuate the at least one electric-motor adjustment drive; and
a lighting unit operably connected to the base unit for receiving electrical energy from the base unit and establishing an electrical connection between the base unit and the operating unit, or between the base unit and the at least one electric-motor adjustment drive.

25. The electric-motor furniture drive of claim 24, wherein the lighting device has at least two plug connectors for respectively connecting the lighting device to the base unit and the operating unit, or for respectively connecting the lighting device to the base unit and the at least one electric-motor adjustment drive.
